(19) United States
(12) Patent Application Publication
(10) Pub. No.: US 2003/0167935 A1
(43) Pub. Date: Sep. 11, 2003

(54) Anchor-net leavescompactor

(76) Inventor: Anuthep Benja-Athon, New York, NY (US)

Correspondence Address: ANUTHEP BENJA-ATHON, M.D., 210 East 36th Street, New York, NY, 10016, US

(21) Appl. No.: 10/092,635

(22) Filed: Mar. 8, 2002

(51) Int. Cl. B30B 9/30

(52) U.S. Cl. 100/8

(57) ABSTRACT

A leave-debris compactor comprises a rod, a plurality of rods, a plate and a lattice of cords. The rod, rods and plate comprising a plurality of hooks, cleats and crevices adaptable to hook, anchor and pull the edges, sections and the cords of this net of cords and any other strands of cords to gather, amass and compact a mound of leaves and debris. The rod can be applied singly or in a plurality of rods. The plate is a dish with or without a plurality of perforations or holes. One of the functions of the perforations is for passing a strut and a plurality of strands of cords. A strut is used to further assist in the adjusting of a height of the rod(s), dish, net of cords and strands of cords. The strut is a pole comprising a plurality of interconnecting tubings, a base and a clamp.

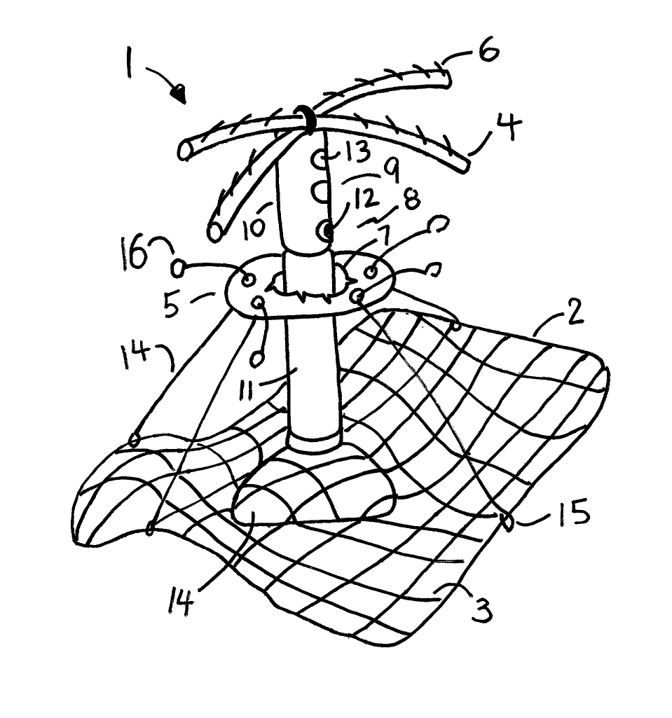

### FIELD OF INVENTION

An anchor means comprises a rod, dish, hook, cleat and crevice means for reversibly attaching a mesh of cords for compacting a huge quantity of fallen leaves and debris.

### BACKGROUND OF THE INVENTION

This applicant filed applications Ser. No. 08/758,498 entitled Gatherer and Compactor of Leaves and Matters in Dec. 2, 1996 and Ser. No. 09/036,912 entitled Extendable-Retractable Hose and Net for Gathering Leaves in Mar. 9, 1998. Both were abandoned.

In the spirit of aforementioned applications, the objective of the present invention is to substantially increase people's efficiency and productivity, decrease the waste of time and costs and the backbreaking, mundane, albeit necessary, choirs in gathering, collecting and disposing of leaves and debris.

Another objective of the present invention is to significantly reduce the use and waste of plastic bags that is environmental pollutant in the process of collecting and disposing of leaves and debris.

Yet another objective of the present invention is to decrease morbidity and mortality by decreasing the physical stress on the cardiovascular and musculoskeletal systems of people who are at risk from performing physical effort associate with the inefficient method of gathering and removing of large quantity of leaves.

In autumn or any other seasons, in North America and throughout the world, the necessary task of trapping, gathering, accumulating, and removing of scattered fallen leaves and matters is a common activity.

There is no good device to perform and accomplish said mundane task. Often one must use all types of inappropriately improvised tools and equipment to achieve above task. Commonly, large plastic or metal heavy containers such as garbage receptacle are used to attempt to scoop, capture, contain and hold these leaves. These garbage receptacles are ineffective to achieve said attempt especially with voluminous collection of leaves that are bulky and springy in quality when they are in bulk. Thus, much effort and time are expended just to capture and hold only small quantity of leaves in a single receptacle.

Moreover, to scoop the leaves into said receptacle, the operator must repetitively tilts the receptacle to the ground to scoop the leaves and then repetitively return said receptacle to upright position to hold the leaves.

In addition, the operator repetitively performed backbreaking activity to scoop leaves with various implements from the ground into said receptacle. The springy and high resistant leaves have to be pushed into and held in said receptacle only to bounce back when the pressure is removed because of the springy quality of the bulky leaves. Said process is inefficient, wastes time and causes injury to the musculoskeletal and cardiovascular systems of the body of the operator.

The environmental hazard is another problem caused by the use of plastic bags. Most households throughout America used plastic bags such as the so-called leave and lawn bags that are readily available in any supermarkets and hardware stores. These bags have similar aforementioned setbacks as with the use of said receptacle and pose more problems. These bags are harder to use and the volume of each bag is too small as compare to the volume created by the gathered leaves to be contained. The lack of rigidity of the structure of said bag dictates that some supportive structure must be used such as said garbage receptacle. The bag is difficult to use as dead space often forms; it is easily torn; and it is costly.

Large quantity of said bags is used per household accounting for immense quantity of bags used throughout America. Almost all of these costly plastic bags are made from petroleum products and not biodegradable. They significantly contribute to the pollution of the environments.

Said circumstances and problems also applied to collecting and harvesting of other things and matters all year round throughout North America.

The present invention is a much more efficient device for said purposes. Furthermore, the present invention eliminates aforementioned pollution of the environment.

### SUMMARY OF THE INVENTION

In North America and throughout the world, the current method of removing fallen leaves is a mundane task wasting precious time and resources. Worse yet, it causes enormous quantity of pollutant being added to the environment in the form of nonbiodegradable plastic bags which are being used in the futile attempt to capture and hold fallen leaves. At best, each plastic bag achieves only to capture a small quantity of said leaves which resist the collection and compaction.

To overcome and resolve all the above problems, the present invention is a leave-debris compactor comprises a rod or a plurality of rods or tubings, a plate or a dish and a lattice of cords. The rod, rods and plate comprising a plurality of hooks, cleats and crevices adaptable to hook, anchor and pull the edges, sections and the cords of said net of cords and any strand of cords or ropes to gather, amass and compact a mound of leaves and debris. The rod can be applied singly or in a plurality of rods. The plate is a dish with or without a plurality of perforations or holes. One of the functions of the perforations is for passing a strut and a plurality of strands of cords. A strut is used to further assist in the adjusting of a height of the rod(s), dish, net of cords and any strand of cords. The strut is a pole comprising a plurality of interconnecting tubings, a base and a clamp. Clamps and clips are other accessory devices to make said components most effective.

### BRIEF DESCRIPTION OF THE DRAWING

A schematic of the present invention.

### PREFERRED EMBODIMENTS OF THE INVENTION

Drawing 1 shows one of the preferred embodiments of a means for amassing fallen leaves and debris henceforth accumulator 1 adaptable to accumulate and compile said leaves and debris into a substantial heap of leaves and debris and compact a mound of said leaves and debris. A net of cords 2 is a component of said means for amassing fallen leaves and debris.

The lattice or network of cords 2 comprises a mesh of natural, synthetic or any combination thereof of stretchable, semi-stretchable, nonstretchable cords, strings, ropes or the like and any combination thereof 3. Semi-stretchable or nonstretchable cords, strings, ropes or the like 3 can effectively hold, embody, and compact a huge mound of springy leaves and heavy debris without breaking or disrupting the continuity and integrity of net of cords 2. Moreover, semi-stretchable or nonstretchable cords, strings, ropes or the like 3 effectively absorb various forms of energy in and forces generated by the amassed and compacted fallen leaves and debris.

Cords, strings, ropes or the like 3 are made from materials such as, but not limited to, synthetic materials such as plastics and their derivatives which confer said desirable physical properties such as stretchability, semi-stretchability and nonstretchability, strength and environmental safety. Both nonbiodegradable and biodegradable synthetic materials can be used. The materials may incorporate other biodegradable substances such as, but not limited to, starch rendering the net of cords biodegradable. Natural and plant substances and materials such as, but not limited to, plants and fibers such as jute plant fibers and substances and any combination thereof can be used.

Drawing 1 further shows a representation of net of cords 2. Although the edges of net of cords 2 are shown to be square, however, it is obvious to one skill in the art that other geometrical boundary configurations, such as, but not limited to a random or irregular, rectangular and circular boundary can be had. The dimensions of net of cords can be varied according to the need and function assigned to net of cords 2. In other words, net of cords 2 may have various widths, lengths and radius ranging from a few feet to several feet.

The second vital component of accumulator 1 is a rod or a plurality of rods 4 and dish, plate or lid-like structure 5. Rod(s) 4 and dish 5 are able to hook, harness, hold and affix any and all cord-like or rope-like structures. In other words, rod(s) 4 or dish 5 together with a plurality of means for anchoring, affixing and fastening of cords and ropes and means for adjusting and dispensing varying lengths of cords 3 and harnesses any component of net of cords 2 and any plurality of strands of cords. A rod(s)-cords or dish-cords assembly is analogous to a hub-spokes. Under the same principle, rod(s) 4 or dish 5 serves several functions such as, but not limited to, hooking, affixing, anchoring, organizing, distributing, dispensing and adjusting the edges and cords of net of cords 2 and the functional and nonfunctional lengths of said plurality of cords 3.

The diagram shows one of the preferred embodiments of the present invention wherein a rod or a plurality of rods 4 comprising a plurality of hooks 6, cleats and crevices (not shown in the drawing). Hooks 6, cleats and crevices are used to hook, anchor, affix and adjust the edges and cords 3 of net of cords 2. The physical properties of each rod may be solid or hollow tubing although various other preferred embodiments can be had within the spirit of the invention and the scope of the claims. The rod and tubing may have various lengths such as inches to several feet. Moreover, each rod may be made to telescope using several interconnecting and telescopic tubings of different cross-sectional dimensions. Of course, hooks 6, cleats and crevices will be designed so that they will not hinder this telescopic feature.

If there is more than one rod 4 being used, a means for holding or organizing a plurality of rods 4 can be located at the intersection of rods 4. Said means is devices such as, but not limited to, a loop, hub and tubing including screws, nuts and bolts that fix rods 4 into a definite but adjustable position. Alternatively, along the line of said telescopic principle, said means may allow rods 4 to rotate or swivel about an axis for ease of shipping and storage.

In theory, fanning, sweeping or rotating rod or rods 4 forms dish that is one of the preferred embodiments of the present invention. In other words, dish 5 is another presentation of a plurality of rod 4. In this embodiment, dish 5 is a solid plate, dish or surface with only crevices and small holes for screws, nuts and bolts for securing hooks 6, cleats and the like.

However, in the manufacturing process of dish 5, to reduce the cost of materials such as plastics and metals, dish 5 can be manufactured from a mold which give extensive perforations throughout dish 5. As a result, dish 5 has an appearance of interwoven plastic rods or strips not unlike a weave bamboo lid. In this embodiment, dish still can be designed to have crevices and small holes for screws, nuts and bolts for securing hooks 6, cleats and the like.

Rod 4 and dish 5 and their said components are made from plastics, Styrofoam, metal, rubber, alloy, plant and wood and any combination thereof. One of the preferred embodiments is that rod(s) 4 and dish 5 are made from material(s) that is light rendering rod(s) 4 and dish 5 to stay above or afloat atop the pile of leaves and debris being formed above net of cords 2. To form accumulator 1, accessory parts are used to unite said components to rod(s) 4 or dish 5 include, but not limited to, screws, clamps, nuts, washers and bolts and various bonding materials such as, but not limited to, adhesive or thermal bonding.

Rod(s) 4 and/or dish 5 and said means being represented by hooks 6, cleats and crevices serve to gather, trap, heap and compact said leaves and debris. Said function is achieved by said plurality of means for anchoring, affixing and fastening of cords and ropes and means for adjusting and dispensing varying lengths of cords 3 of net of cords 2. As a result said devices produce an opposing force to that produce by the energy including potential energy in said leaves and debris.

At this stage of the development, accumulator 1 can effectively operate to gather, amass, compile and compact leaves and debris using either a rod 4, rod(s) 4, dish 5 or any combination thereof with all said components including net of cords 3. In other words, no other devices neither called for nor needed.

Briefly, fallen leaves and debris are swept into the confine of net of cords 2. The heap of leaves and debris are amassed, trapped, heaped and compacted by the net of cords 2. Rod(s) 4 or dish 5 is placed above said heap of leaves and debris. Rod(s) 4 or dish 5 adaptable to remain afloat above said pile of leaves and debris being formed above net of cords 2 because of its broad design and light weight. After sufficient heap of leaves and debris was formed, either the edges or the cords of mesh of cords 2 are hooked, affixed and pulled by a plurality of hooks 6, cleats and crevices and the like on rod(s) 4 or dish 5. As need be at various stages of said process, different edges, sections and cords 3 of net of cords 2 are hooked, affixed and pulled by different hooks 6, cleats and crevices during said process.

By said process, said edges, sections and cords 3 of net of cords 2 form a plurality of vestibules for admitting said leaves and debris into net of cords 2 as leaves and debris continue to be piled into net of cords 2. Having compact leaves and debris, accumulator 1 is disengaged from net of cord 2 and a means for holding edges of net of cords 2 is used. Said means for holding is such as, but not limited to, a flexible wire and plastic strip with ratchet and loop means for forming a noose of variable sizes.

However, another perferred embodiments of the present invention as shown in the drawing is to have dish 5 with a plurality of perforations 7 for passing strut 8 and a plurality of strands of cords 9. It is to be noted that in an earlier preferred embodiment, dish 5 may have other types of perforations, holes or crevices for the use of screws, nuts and bolts to secure hooks 6, cleats and the like.

If dish 5 has perforations as described supra, hooks 6, and crevices can be positioned on the inner rim, in addition to the outer rim, upper and lower surfaces of dish 5.

Another added component of accumulator 1 is strut 8. Strut 8 comprises a pole 9 or the like comprising a plurality of interconnecting shorter tubings 10 and 11. The number of tubings can number from two to more tubings. There are several means for connecting said tubings to form pole 9 such as, but not limited to, complementary male and female fittings with or without outer and inner threads in the walls of two adjacent tubings, a spring-powered peg 12 in tubing 11 and a plurality of complementary holes 13 in the wall of tubing 10. The purpose of said means for connecting is to adjust and vary the lengths of strut 8 as represented by a double arrow 14. Strut 8 can be made from various types of plastics such as, but not limited to polyvinyl chloride or PVC, metals such as, but not limited to, aluminium, steel, copper, alloys and various types of light, strong and durable plants such as bamboo.

A base means 14 for footing said tubing 11 is shown. Various types and configurations of bases can be had such as, but not limited to, a dome, a plate, a dish and spokes.

A plurality of strands of cords 14 are used for means for trapping, heaping, compacting said leaves and debris. Various physical properties of strands of cords 14 such as, but not limited to, elasticity, rigidity or combination thereof are some of the preferred embodiments conferring the most effectiveness and ease of use and application of strands of cords.

Each strand of cord 14 comprises a first end and a second end. Said first end comprises means for reversibly engaging strand of cord 14 to net of cords 2. Said means for reversibly engaging is a hook, clip, clamp, clasp, loop or the like 15. Said means can be spring-loaded.

Said second end of strand of cord 14 comprises a hook, clip, clamp, clasp, loop or the like 16. Devices 16 can be spring-loaded. Said devices 16 serve as means for variably adjust and affixing a functional length of each strand of cord 14 during said process of trapping, heaping, compacting said leaves and debris. Moreover, strands of cords 14 assist net of cords 2 to heap, accumulate and compact said leaves and debris. Plurality of strands of cords 14 and net of cords 2 oppose the force produce by the energy including potential energy in said fallen leaves and debris.

A plurality of clamps or clips such as, but not limited to, spring clamps or clips is incorporated into accumulator 1. Said clamps and clips can be used on any components of accumulator 1 including but not limited to strut 8. The purpose of said clamps and clips are a means for reversibly securing and affixing any and all components of accumulator 1. Furthermore, said clamps and clips serve as a means for affixing and adjusting a height of said net of cords and all devices which are either directly or indirectly attached or related to strut 4 discussed herein and supra.

Moreover, rod(s) 4 or dish 5 and said plurality of means for anchoring, affixing and fastening of cords and ropes and means for adjusting and dispensing varying lengths of cords with or without strands of cords form a plurality of variable and adjustable vestibule means for admitting said leaves and debris into said means for amassing.

Alternatively, accumulator 1 can operate to gather, amass and compact leaves and debris in said preferred setup wherein strut 8 is used adjust the height of rod(s) 4, dish 5 and a plurality of strands of cords 14.

Although the preferred embodiments of this invention have been described, it will be appreciated by those skilled in the art that adaptations and variations may be made without departing from the spirit of the invention and the scope of the claims.

Although one of the preferred embodiments of the present invention is shown as rod(s) 4 and dish 5, it is obvious to those skill in the art that other similar devices with similar or dissimilar configurations, geometry, sizes, dimensions and components can be used or incorporated into the present invention without departing from the spirit of the invention and the scope of the claims. For example, a plate, platform, a spool-like or a spherical device with said components may be used.

Although the preferred embodiments of the present invention have been described, it will be appreciated by those skill in the art that other materials, such as, but not limited to, rigid, semi-stretchable or elastic cord, rope, canvas, burlap can be used.

Although cleats, hooks, clamps, grasps, loops and clips are the preferred components of this invention, it will be appreciated by those skilled in the art that other devices can be used and incorporated into the present invention without departing from the spirit of the invention and the scope of the claims.

Although one of the preferred applications of the present invention have been described, it will be appreciated by those skill in the art that one single component, two components or multiple and variable combinations of said components of the present invention may be used without departing from the spirit of the invention and the scope of the claims.

1. A means for amassing fallen leaves and debris adaptable to compile a substantial heap of said leaves and debris and to compact a mound of said leaves and debris comprises:
a net of cords;
means for anchoring a plurality of cords;
means for gathering said leaves and debris;
means for heaping said leaves and debris;
means for trapping said leaves and debris;
means for compacting said leaves and debris; and
means for forming a plurality of variable and adjustable vestibule means for further admitting said leaves and debris into said means for amassing.

2. The means for amassing fallen leaves and debris according to claim 1 wherein said means for anchoring a plurality of cords comprises:
a means for harnessing a plurality of cords;
a means for affixing a plurality of cords; and
a plurality of fastener means for dispensing adjustable and variable functional lengths of a plurality of cords.

3. The means for harnessing a plurality of cords according to claim 2 is a rod means for attaching a plurality of cord comprising a hook means for anchoring a plurality of cords.

4. The means for harnessing a plurality of cords according to claim 2 is a dish means for attaching a plurality of cord comprising means for anchoring a plurality of cords.

5. The dish means for attaching according to claim 4 comprises
a plurality of hooks;
a plurality of cleats;
a plurality of crevices;
a plurality of perforations;
means for engaging and varying a functional length of a plurality of strands of cords; and
a plurality of perforations for struts, screws, nuts and bolts.

6. The means for amassing fallen leaves and debris according to claim 1 wherein said means for heaping said leaves and debris is a means for anchoring a plurality of cords.

7. The means for amassing fallen leaves and debris according to claim 1 wherein said means for trapping said leaves and debris is a means for anchoring a plurality of cords.

8. The means for amassing fallen leaves and debris according to claim 1 wherein said means for compacting said leaves and debris is a means for anchoring a plurality of cords.

9. The means for amassing fallen leaves and debris according to claim 1 wherein said means for gathering said leaves and debris is a strut comprises:
a pole comprising a plurality of interconnecting tubings, a plurality of spring-powered pegs and a plurality of holes on the wall of said tubings;
a base means for footing said pole; and
means for reversibly affixing and adjusting a height of a net of cords.

10. The strut according to claim 2 wherein said means for reversibly affixing and adjusting a height of a net of cords comprises a clamp.

11. The means for amassing fallen leaves and debris according to claim 1 wherein said means for trapping said leaves and debris is a plurality of strands of cords wherein a strand of cord comprises:
a first end;
a second end;
a means for reversibly connecting a first end of said cord to said net of cords;
a means for reversibly securing said second end of said strand of cord to a portion of said strand of cord and to said means for compacting said leaves and debris; and
a loop means for reversibly engaging said strand of cord to said means for compacting said leaves and debris of said strain of cord.

12. The means for reversibly connecting a first end of the cord in claim 5 is a hook means for reversibly engaging said first end of the cord to said net of cords.

13. The means for reversibly securing a second end of said strand of cord to a portion of said strand of cord and to said means for compacting said leaves and debris in claim 5 is a clasp means for reversibly securing said second end of said strand of cord to a portion of said strand of cord and to said means for compacting said leaves and debris.

14. The means for amassing fallen leaves and debris according to claim 1 wherein said means for heaping said leaves and debris is a plurality of strands of cords.

15. The means for amassing fallen leaves and debris according to claim 1 wherein said means for forming a plurality of variable vestibule means for admitting said leaves and debris into said means for amassing comprises:
said net of cords;
said means for anchoring a plurality of cords; and
a plurality of strands of cords.

16. A means for anchoring a plurality of cords adaptable to amass, trap, heap and compact a substantial mound of fallen leaves and debris wherein an anchoring means provides a platform for hooking, securing and varying the lengths of a plurality of cords comprises:
means for anchoring a plurality of cords;
means for hooking a plurality of cords;
means for securing a plurality of cords;
said means for varying the lengths of a plurality of cords; and
means for forming a plurality of variable and adjustable vestibule means for further admitting said leaves and debris into said means for amassing.

17. The means for anchoring a plurality of cords adaptable to amass, trap, heap and compact a substantial mound of fallen leaves and debris according to claim 16 wherein said anchoring means provides a platform for hooking, securing and varying the lengths of a plurality of cords is a rod means for anchoring a plurality of cords comprises:
means for hooking a plurality of cords;
means for securing a plurality of cords;
said means for varying the lengths of a plurality of cords; and
means for forming a plurality of variable and adjustable vestibule means for further admitting said leaves and debris into said means for amassing.

18. The means for anchoring a plurality of cords adaptable to amass, trap, heap and compact a substantial mound of fallen leaves and debris according to claim 16 wherein said anchoring means provides a platform for hooking, securing and varying the lengths of a plurality of cords is a plate means for anchoring a plurality of cords comprises:
means for hooking a plurality of cords;
means for securing a plurality of cords;
said means for varying the lengths of a plurality of cords; and
means for forming a plurality of variable and adjustable vestibule means for further admitting said leaves and debris into said means for amassing.
